(19) United States
(12) Patent Application Publication
(10) Pub. No.: US 2006/0225404 A1
(43) Pub. Date: Oct. 12, 2006

(54) Vertical or short take off and landing vehicle

(76) Inventor: Sudarshan Paul Dev, New Caanan, CT (US)

Correspondence Address: PERMAN & GREEN, 425 POST ROAD, FAIRFIELD, CT, 06824, US

(21) Appl. No.: 11/226,619

(22) Filed: Sep. 13, 2005

Related U.S. Application Data
(63) Continuation-in-part of application No. 11/201,441, filed on Aug. 10, 2005.
Application No. 11/201,441 is a continuation of application No. 10/635,956, filed on Aug. 7, 2003, now Pat. No. 6,988,357.
Application No. 10/635,956 is a continuation of application No. 09/947,002, filed on Sep. 5, 2001, now Pat. No. 6,647,707.
(60) Provisional application No. 60/609,696, filed on Sep. 13, 2004.
(60) Provisional application No. 60/609,636, filed on Sep. 14, 2004.

(51) Int. Cl. F02K 11/00

(52) U.S. Cl. 60/200.1

(57) ABSTRACT

A vehicle with a body, an engine, and an engine driven fan. The engine is connected to the body. The engine driven fan is mounted to the body for providing thrust capable of effecting controlled motion of the vehicle in at least one direction. The fan has a fan section drivingly connected to the engine. The fan section has fan blades. At least one of the fan blades has a tip jet and boundary layer control slot formed therein.

This application claims the benefit of U.S. Provisional Application No. 60/609,696 filed Sept. 13, 2004 and is a continuation-in-part of copending application Ser. No. 11/201,441, filed Aug. 10, 2005, which is a continuation of application Ser. No. 10/635,956, field Aug. 7, 2003, which is a continuation of application Ser. No. 09/947,002, filed Sept. 5, 2001, (now Pat. No. 6,647,707)

### BACKGROUND

1. Field

The disclosed embodiments relate to vertical and short take-off and landing (VSTOL) vehicles and, more particularly, to a VSTOL vehicle with ducted lift and thrust fan(s).

2. Brief Description of Related Developments

The growth of the planets urban population centers is expected to continue for the foreseeable future at a geometric pace. It is expected that in the not so distant future, the great majority of the planets population will reside or work in these ever growing urban centers. Conventional transportation systems are however hard pressed by the demands to service the burgeoning urban centers and are not expected to keep apace with satisfying the anticipated transport demand. This results in undesired reduced services and living standards for significant portions of the population in urban centers. As may be realized, surface or near-surface borne transport systems whether ground, underground, or waterborne transport, are extremely limited by operating substantially in only Z-D space. Increase in transport capacity in this case is available, upon realizing maximum transport density, by increasing transport system area (i.e. commanding larger surface area for the transport system), which is very difficult to achieve, as well as wasteful, in crowded urban centers. Airborne transportation systems have an inherent advantage over surface borne systems, as airborne systems are capable of using a third dimension, theoretically allowing much easier growth in capacity. Conventional air transportation systems sufficiently efficient for mass use (e.g. airplanes). However, give up a large portion of their inherent advantage over surface transport systems, by employing large Z-D surfaces (i.e. runways, airports) for transitioning between ground and airborne mode. Conventional vertical or short take off and landing (VISTOL) vehicles, though not subject to the limitations of airplanes, suffer from other inefficiencies and problems.

Rotor Dimensions/Danger in Confined Spaces:

Helicopters maximize lift by use of a large rotor. However, the large rotor is subject to collisions with people, buildings, wires, trees and other objects, and makes it not very usable in an urban environment. It is desired that an urban flyer be about the size and shape of a car, to allow maneuvering through city streets.

Thrust/Weight Ratio for Lift System:

V/STOL systems should have the lowest possible weight for the complete lifting system, including engine, fan or rotor, any transmission and all accessories such as nacelles, tail rotors, etc. In conventional lift systems, thrust for a given power is increased by larger disk area, such as in helicopters, although the multi-stage gear-box and transmission systems used in conventional fan or rotor lift/thrust systems also adds a lot of weight and thus erodes the thrust to weight ratio.

Provisions for Engine-Out Situations

For safety of manned flight, it is desirable to have multiple engines such that the loss of performance from any one engine does not result in loss of control and enables continued safety of flight in any operating mode. In conventional helicopters, this is achieved by using two or three engines with combining gear-boxes and slipping clutches. In conventional tilt-rotor aircraft (e.g. V-22), this is achieved by cross shafting the engines from one wing-tip to the other wing-tip. These transmission systems add significant weight that directly detracts from aircraft payload. Mechanical geared transmissions are also often cited as a maintenance issue.

Maximizing Lifting ‘Disk’ Area within Compact Vehicle Dimensions:

The graphs in FIG. 1 indicate that, for a specific aircraft weight, the power for hover diminishes by the square-root of disk loading, or alternatively, by square root of the lifting surface area of the rotor or lift fan. However, very large engine-driven fans are not conducive to installation within a relatively compact, car-like airframe desirable for use in urban environment.

Minimization of Noise and Infra-Red Emissions:

Helicopter rotor blades reach transonic speeds relative to local air flow at the blade tips. This creates shock noise that is heard as the ‘whop-whop’ sound from great distances. Lift jets have high gas discharge velocities, and hence create very high jet noise (proportional to 8^{th} power of jet velocity). In the urban environment, and in the interest of stealth, neither of these noises is acceptable.

Review of Conventional V/STOL Systems:

Conventional state-of-the-art V/STOL systems can be divided into 3 main categories:

Aircraft using an open rotor for lift, such as helicopters and tilt-rotor aircraft

Those using turbojets and turbofans with thrust vectoring for jet-lift, such as the Harrier

Those with a variable lift/thrust system, such as the Lockheed Joint Strike Fighter (JSF).

All of these systems however, suffer from major limitations. These are summarized below:

Helicopters:

While these look good on a golf course, their transonic rotor tips are noisy and beat up quite a storm. Additionally, their application is limited to terrains devoid of surrounding trees, wires, buildings, etc.

Tilt rotors:

These, such as the Bell Helicopter V-22 and Bell Augusta BA-609 have speeds and ranges that are better than traditional helicopters. However, with rotors that are located on the tips of wings, their space claim and danger from wires, trees or buildings is even greater. They also incur a large penalty due to cross-shafts and swivel gear boxes.

The Harrier:

employs a compact lift system that offers high-subsonic speed potential. However, the downward directed high jet velocity creates ground erosion and thundering noise; while the high fuel consumption limits range and endurance.

Joint Strike Fighter

The JSF has been optimized for transonic flight, with occasional take-off or landing at near-zero speed. This causes the Boeing's X-32 to suffers from similar limitations as the Harrier; Lockheed's X-35 lift-fan employs a complex clutch and gear assemblies operating at very high horsepower levels.

By contrast, urban flyers are expected to spend a large amount of time at near-zero velocity. As indicated by the FIGS. 1A-1B, the hovering and low velocity flight cause a shift in the optimum design of the lift/thrust system to ultra-high bypass ratios.

Further, given the previously mentioned limitations of an open-rotor, high bypass ducted fans are therefore the preferred solution for V/STOL aircraft. However, such an ultra-high bypass ratio fan must have relatively low tip speeds, for reasons of achieving low disk loading combined with high aerodynamic efficiency. Such low tip speeds can be obtained either by the use of multi-stage gear boxes, or by use of a very large number of small power turbine stages.

Each of the conventional drive systems thus involves a large number of heavy components that introduce additional cost and weight, and often reduce reliability of the entire propulsion system.

The vehicles of the exemplary embodiments overcome the problems and limitations of conventional systems as will be described in greater detail below. By comparison to conventional systems, the vehicles in the exemplary embodiments avoid gears and shafts by use of a lift/thrust fan system that offers the optimum bypass ratio (≈ 50:1) with high thrust/weight ratio (≈ 25:1). The fan system in the exemplary embodiment may have an aspirated fan with an ultra-high-bypass ratio and fan without the expensive and heavy gear/shaft system or multi-stage power turbines of conventional system; thereby allowing for an efficient, light-weight turbofan with increased thrust-to-weight, as well as greater reliability through reduced number of components as will be described below. The vehicles of the exemplary embodiments may have compact, car-like air frame but overcome the problems with conventional large engine-driven fans by use of multiple lift/thrust fans, some driven directly by the engines, the others driven by using pneumatic power (pressurized air) and electrical power from the engines or engine-fans. This allows increased lifting surface area while still using relatively small lift-fans for advantages in vehicle configuration and layout.

The lift/thrust fan system of the vehicles in the exemplary embodiments, lands on a section of the graphs in FIGS. 1A-1B identifying an optimal fan system with low rotor tip speeds, low overall gas exit velocity and encapsulation within a duct (nacelle) that may be lined with noise-absorbing materials. Further, to minimize temperature of exhaust gases that may possibly impinge on objects in an urban environment, as well as detectable Infra-Red emissions, the gases from the core engine are to be pre-mixed with the cooler fan airflow prior to exhaust from the nacelle. Moreover, the multi-fan arrangement of the lift/thrust system of the vehicles in the exemplary embodiment may achieve the desired redundancy without excessive weight of conventional power transfer systems, using power transfer by combination of ducting of high pressure air and by electric power transfer through the use of light-weight, high-speed, motors/generators.

Mobility on Ground when Feasible: Flight, particularly flight at low speeds, consumes much larger power than mobility on the ground by use of wheels or even tracks. This is true whether low speed flight is achieved by wings (induced drag) or by use of lifting rotors or lifting fans (hover power). Therefore, if a vehicle can achieve some level of low speed mobility on the ground, then vehicle endurance can be increased significantly. Also, mobility on the ground, such as by use of electric motors, can often be quieter (hence stealthier) than hovering and low-speed flight. As will be described in greater detail below, the vehicles in the exemplary embodiments achieve a measure of power transfer in engine-out situations by electrical means, the same engine-driven generators can provide electric power to wheel motors for a limited measure of ground mobility.

### SUMMARY OF EXEMPLARY EMBODIMENTS

In accordance with the one embodiment, a vehicle is provided. The vehicle has a body, an engine, and an engine driven fan. The engine is connected to the body. The engine driven fan is mounted to the body for providing thrust capable of effecting controlled motion of the vehicle in at least one direction. The fan has a fan section drivingly connected to the engine. The fan section has fan blades. At least one of the fan blades has a tip jet and boundary layer control slot formed therein.

In accordance with another embodiment, a vehicle is provided. The vehicle has a body, an engine and an engine driven fan. The engine is connected to the body. The engine driven fan is mounted to the body for providing thrust capable of effecting controlled motion of the vehicle in at least one direction. The fan has an active aspirated fan rotor with upper surface blowing. The fan rotor is operably coupled to the engine for engine exhaust gas to aspirate the fan rotor.

### BRIEF DESCRIPTION OF THE DRAWINGS

The foregoing aspects and other features of the present invention are explained in the following description, taken in connection with the accompanying drawings, wherein:

FIGS. 1A-1B are graphs with lines that respectively illustrate the relationship between Lift/Hover Power ratio (lbs/hp) and Disk Loading (lbs/sq. ft.) in FIG. 1A, and between Hover Power (hp/1000 lbs) and Disk Area (sq. ft./1000 lbs.) in FIG. 1B, of lift/thrust systems for a vertical takeoff and landing (VTOL) vehicle of a given weight, and showing the corresponding characteristics of lift/thrust systems incorporating features in accordance with an exemplary embodiment;

FIGS. 2A-2C are respectively schematic plan, side elevation and end elevation views of a vehicle incorporating features in accordance with an exemplary embodiment and a representative payload P of the vehicle;

FIGS. 3A-3C are respectively schematic plan, side and end elevation views of vehicles similar to the vehicle in FIGS. 2A-2C and payloads arranged in a representative transport space V;

FIG. 4 is a cross sectional view of a portion of the lift/thrust system of the vehicle in FIG. 2A;

FIGS. 4A-4B are views respectively taken along view lines A-A and B-B in FIG. 4;

FIGS. 5-5A are respectively an enlarged cross-sectional view of the engine and lift/trust fan of the lift/trust system portion shown in FIG. 4. and a chord-wise cross-sectional view of a fan blade of the lift/trust fan;

FIG. 6 is another schematic cross sectional view of a portion of the lift/thrust system of the vehicle in FIG. 2A in accordance with another exemplary embodiment;

FIG. 7 is yet another schematic cross sectional view of a portion of the lift/thrust system of a vehicle in accordance with yet another exemplary embodiment;

FIG. 8 is still another schematic cross sectional view of a portion of the lift/thrust system of a vehicle in accordance with still another exemplary embodiment;

FIG. 9 is a schematic cross-sectional view of a exhaust duct system of the lift/trust system of the vehicle in FIG. 2A and an occupant of the vehicle;

FIG. 10 is a schematic perspective view of a vehicle in accordance with another exemplary embodiment and representative payloads S, SA, SB;

FIGS. 11A-11D are schematic perspective views of the vehicle in FIG. 2A shown with different payload configurations;

FIG. 12 is a schematic plan view of a vehicle in accordance with another exemplary embodiment and payload P;

FIGS. 12A-12B are schematic cross-sectional views of respectively showing an engine driven lift/trust fan and electrically driven lift/trust fan of the vehicle lift/trust system in FIG. 12;

FIGS. 13A-13B are schematic plan views respectively of the engine driven lift/trust fan and electrically driven lift/trust fan shown in FIGS. 12A-12B;

FIGS. 14A-14C are respectively schematic plan, side and end elevation views of a vehicle in accordance with yet another exemplary embodiment and a representative transport vehicle; and

FIGS. 15A-15C are respectively schematic cross sectional views of the vehicle in FIG. 14A and a partial bottom view of the vehicle.

### DETAILED DESCRIPTION OF THE EXEMPLARY EMBODIMENT(s)

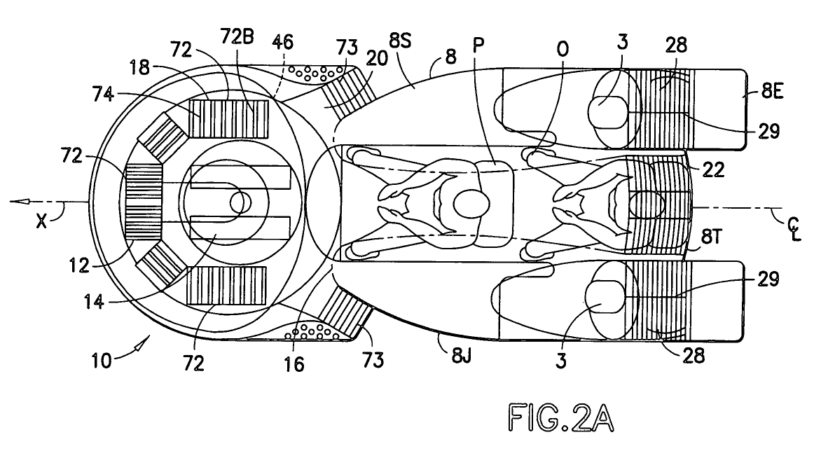

Referring to FIGS. 2A-2C, plan, side and end elevation views of a vehicle 10 incorporating features of the disclosed embodiments and representative payload P are illustrated. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

The vehicle 10 is a VISTOL vehicle and is capable of operating within an urban environment without employing specially prepared areas within the urban environment for allowing the use of the vehicle. The vehicle 10 generally has a body 8 capable of holding a useful payload P. The payload P is representatively shown in FIGS. 2A-2C as being one or more occupants and/or transport containers capable of holding desired transport materials items. In alternate embodiments, the payload P may be of any desired type. The vehicle 10 also has engine(s) 2, motor/generator(s) 3 and a lift/thrust fan system 4. The engine(s) 2, motor/generator(s) 3 and lift/thrust system 4 are connected to the body. The lift/thrust system 4 has fans 12, 28 are capable of generating both lift and thrust for the VISTOL vehicle 10. The fans 12, 28 of the lift/thrust system 4 may be ducted. The fan ducts (nacelles) may be located in the body, and may communicate with vectorable/variable louvers and nozzles used for lift and thrust via connecting ducts. A fan 12 of the lift/thrust system is engine driven powered directly by exhaust gases from the engine. The fan blades are positively aspirated for torque and improved aerodynamic performance. Fan 12 may drive a generator that powers motor(s) 3. Fans 28 of the lift/thrust system are electrically driven by motor(s) 3. The exhaust from fans 12, 28 ducted through the exhaust louvers/nozzles is capable of providing controlled movement of the vehicle in all six (6) degrees of freedom. The vehicle 10 has an active ground support/transport system 7 capable of supporting and allowing the vehicle to move on a ground surface. The ground support/transport system has electric motors 26 for powering the motive components of the ground system 7. The motors 26 are in turn powered by the generator 24 driven by fan 12.

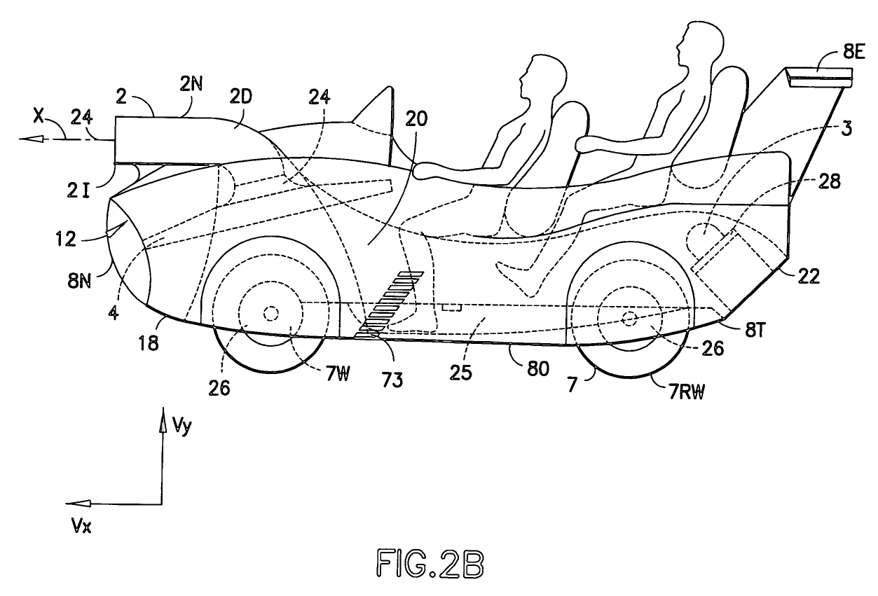

In greater detail, and with reference still to FIGS. 2A-2C, the vehicle 10 in this exemplary embodiment has a generally elongated shape with a longitudinal axis of symmetry CL that is substantially aligned with what may be referred to for example purposes as a forward direction of travel of the vehicle (indicated by arrow X in FIG. 2A). As seen best in FIGS. 2A, and 2C the body 8 may have a payload holding area configured so that the payload P is positioned substantially symmetrically relative to the longitudinal axis C_{L}. In alternate embodiments, the payload may be positioned in any desired manner in/on the body. In the exemplary embodiment shown, the payload holding area may include a cockpit or occupant area 0 and/or cargo holding area disposed in a generally central location on the body and extending as desired longitudinally along the body. The occupants are shown in FIGS. 2A-2C arranged in a tandem seating arrangement for example purposes and in alternate embodiments the occupants may be positioned in any desired arrangement. In the embodiment shown, the body 8 has sponsors 8S astride the cockpit. The sponsors may be configured to carry stores such as fuel and other consumables, or may have space for holding more payload. The body 8 of the vehicle may be sized to operate readily within spaces in an urban environment (e.g. car or light truck size). Some parameters of exemplary configurations of vehicle 10 are identified in table 1, which will be described further below. As seen in FIGS. 3A-3C, in the exemplary embodiment, the vehicle body may be dimensioned to allow one or more vehicles) to be accommodated in a standard storage space V of a desired conventional transport. For example, the available space envelope V of a conventional transport system storage space, such as the storage space envelope of a V-22 “osprey” aircraft, is illustrated in FIGS. 3A-3C. In the exemplary embodiment, two vehicles 10 may be positioned in tandem arrangement in space envelope V. As may be realized, vehicle(s) 10 may load/unload themselves into/out of the storage space using the ground support/transport system 7 as will be described below.

Referring again to FIGS. 2A-2C, the outer surface 8O of the body may have any desired shape. In the embodiment shown, the body outer surface is shaped to be aerodynamically efficient and provide desired lift to drag (L/D) ratios over the projected range speeds of the vehicle. The body may also have empenage or any other desired projecting aerodynamic surfaces to provide desired aerodynamic performance to vehicle 10. As noted before, the vehicle 10 has an engine 2 that powers the vehicle. In the embodiment shown in FIGS. 2A-2C, vehicle 10 has one engine 2, though in alternate embodiments the vehicle may have any desired number of engines. The engine 2 may be a turbojet engine, such as for example a “commercial off the shelf” (COTS) turbojet engine, or a nested gas core belt turbo jet engine from D-STAR Engineering, a suitable example of which is disclosed in U.S. Pat. No. 6,647,707, issued Nov. 18, 2004 and U.S. patent application Ser. No. 10/635,956 filed Aug. 7, 2003, both of which are incorporated by reference herein in their entirety. In this exemplary embodiment, the engine 2 located at the nose section 8N of vehicle body substantially on center. The engine 2 may be located in a dedicated engine nacelle 2N. The engine 2 in this embodiment may be oriented so that engine axis 3A, which, in the case of an axisymmetric nacelle 2N may be coincident with the nacelle axis of symmetry, is substantially aligned with the axis or vector of forward vehicle travel (indicated by arrow X in FIG. 2B). In alternate embodiments, the engine 2 may have any other desired orientation. As also noted before, the vehicle 10 has a fan system 4 for generating lift and thrust, as well as generating control forces and torques providing the vehicle 10 with controlled movement in all six degrees of freedom. In this embodiment, the fans 12, 28 of the fan system 4 are located in a duct system within the body 4. In alternate embodiments, the fan ducts of nacelles may be located outside the body. As seen in FIG. 2A, the fans 12, 28 are distributed longitudinally along the body. In this embodiment fans are located near the nose 8N and near thee tail 8T of the body. In alternate embodiments, the fans of the fan system may be distributed in any other desired arrangement.

The vehicle fan system 4 in the embodiment shown in FIGS. 2A-2C has one large Fan 12 in the nose section, with air inlet grills 14 just in front of the windshield 16 which is a region of high air pressure during forward flight/travel. In this embodiment the fan 12 is centered relative to vehicle center line CL. Pressurized air from the fan 12 is exhausted through louvers 18 in the nose under surface, but is also ducted by ducts 20 to either side of the cockpit and to the tail region 8T and exhausted through additional louver sets 22 for balance and controllability, and for thrust in the cruise mode. For mobility on the ground, the fan 12 may also be coupled to a light-weight, high-speed permanent magnet generator 24 and the electric power is routed via suitable transmission lines 25 to wheel motors 26 on the front or all wheel pairs. In flight, this spare electric power is used to power the two electric lift/thrust fans 28 in the tail for additional lift, thrust and stability.

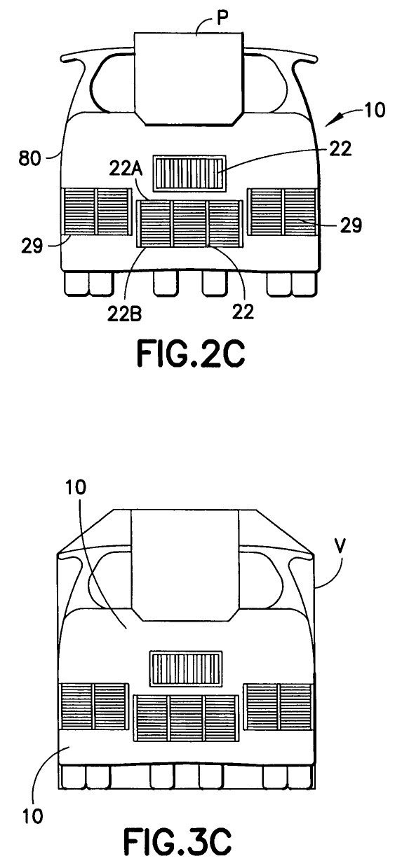

Referring now to FIG. 4 there is shown a schematic cross-sectional view of the fan 12 and fan duct 46 in the nose section 8N of vehicle 10. The fan 12 is a shaft-less, gear-less turbo-fan that can be conceived of as a tip-jet driven rotor system 40 with upper surface blowing to enhance blade section lift coefficients for reduced tip speeds and absence of stall, and with encapsulation into duct 46, with louvers at the bottom of the duct to provide thrust vectoring and flow management. The hot gases for the tip jets and for upper surface blowing may be provided by engine 2E (similar to engine 2 in FIG. 2A except as otherwise noted) as will be described below. The fan 12 may offer an optimum bypass ratio of about 50:1 with high thrust/weight ratio (about 25:1).

As will also be described in greater detail below, the fan 12 is coupled to the engine without the heavy, expensive and maintenance-prone gear box that has been conventionally used to create ultra-high bypass ratios.

The fan 12 in vehicle 10 is a part of a combined lift/thrust system 4 with the slotted-blade power-aspirated-fan rotor 42 and core engine 2E in duct 46 with down-facing actuated louvers 18 (see FIG. 2B) for providing a controllable amount of lift, and with ducting of some or all of the pressurized fan air for exhausting through aft-facing nozzles 22 for high-speed operation of the air vehicle.

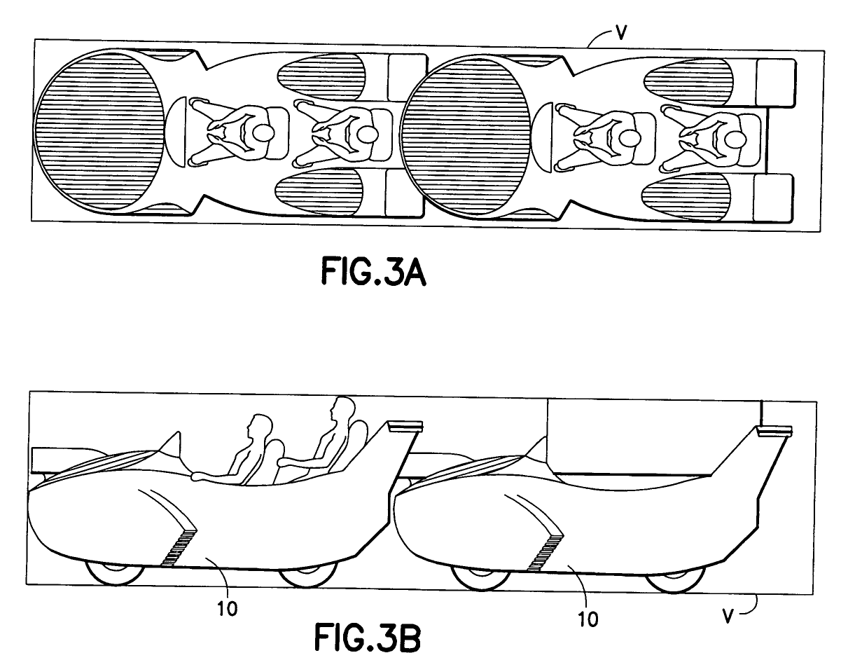

Still referring to FIG. 4, in this exemplary embodiment, the core engine 25 is closely coupled to the fan 12. The gas turbine core engine 2E generally comprises a compressor section, combustor section and turbine section, and the hot gases from the turbine section exhaust directly into the fan rotor system 40 as will be described below. In the embodiment shown in FIGS. 2A-2C, the core engine 2 is connected to the fan 12 exhaust duct 20, having a general elbow shape, and directing hot gases from the engine into the fan rotor system 40. In the embodiment shown in FIG. 4 the core engine 2E may be axi-symmetrically positioned in the inlet portion 52 of the duct 46. The core engine 2E may be coaxial with the rotor 42 of fan 12. In the embodiment shown in FIG. 4, the axis of rotation FA of fan rotor 42, with which the engine axis is substantially coincident, is angled forwards (in the direction indicated by vehicle reference axis VX, in FIG. 2B, relative to the vertical axis VY of the vehicle 10. When the vehicle is in a level (with respect to the ground) attitude the vehicle reference frame is substantially aligned with the ground reference frame. As may be realized from FIG. 4, which shows the orientation of the engine 2E, fan 12 and duct 46 when vehicle 10 is level (i.e. VY is aligned with Y) the fan axis FA is angled forwards relative to the global vertical axis Y when the vehicle is in a level attitude. The vehicle ID may be in a level attitude when resting on ground/transport support system 7, and when in level forward flight (indicated by arrow X in FIG. 2B) the forward tilt angle F between fan axis FA and vehicle vertical axis VY is established so that the fan axis FA is substantially aligned with global vertical axis Y when vehicle 10 is in a slight nose up attitude as may occur when the vehicle is in hover or in a flared attitude transitioning between horizontal flight and vertical hover. As may be realized, the orientation of the engine 2E relative to fan axis FA in this exemplary embodiment, (i.e. core engine 2E is co-axial with the fan axis) mitigates the potential for engine hot gas ingestion into the engine 2E because the engine inlet 44I is in a centered position away from the axi-symmetric vortexes generated by the fan exhaust around the periphery of the fan. As may also be realized, the ultra high bypass ratio of the fan 12 further mitigates the potential for engine hot gas ingestion. A suitable support system such as stator struts (not shown), capable of supporting static and dynamic loads from the core engine 2E anchors the core engine to the duct 46 or any other suitable structure of the vehicle 10. For example the engine support system may be attached to a casing 44C of the engine, and to a suitable surface of duct 46. Referring also to FIGS. 5-5A, a coupling section 58 connects the core engine 2E and fan rotor 42. Coupling section 58 is configured to direct exhaust gases from the static axi-symmetrical exhaust 44E of the core engine into the spinning or spinable axi-symmetrical inlet 42I of the fan rotor 42. In the embodiment shown in FIG. 5, the coupling section 58 may also provide a mechanical attachment for fan rotor 42 to the core engine 2E. In this case, the coupling section 58 may be a hubless ring section with inner and outer rings attached respectively to the static core engine exhaust and rotatable fan inlet. Radial and axial loads (static and dynamic) may be supported with conventional bearings arrayed between static and rotatable rings. Suitable seals, such as labyrinth or brush seals, may be used to prevent exhaust gas from escaping from the coupling section and for protecting the bearings from hot exhaust gases. In another exemplary embodiment, the coupling section may not serve as mechanical attachment retaining the fan to the core engine, and serving to direct gases from the static axi-symmetrical exhaust of the engine to the rotatable axi-symmetrical inlet of the fan.

As noted before the fan rotor 42 is aspirated. The blades 60 of the rotor 42 may have spanwise gas passages that communicate with slots on the upper surfaces of the blades, and with blade tip jets. As seen in FIG. 5-5A, the inlet 42I is suitably shaped to direct engine exhaust gases (indicated by arrows E) into the blade ducts or gas passages 60A, B. Fan rotor 42 may have any suitable number of fan blades 60 (two are shown in FIGS. 4-5 for example purposes). As seen best in FIG. 5A, the fan blades are shaped as desired (in both airfoil section and plan) to generate the desired fan performance for an ultra-bypass ratio fan. In this embodiment, the fan blades may extend substantially across the duct 46 at fan duct section 46F as shown in FIG. 4. Minimal clearance may be provided at the fan blade to reduce fan loss. A tip (not shown) ring may connect the tips of the fan blades to each other providing improved structural rigidity and strength to the fan blades and improved fan performance. Suitable seals such as brush seals may be used to minimize loss between the outer fan ring and duct 46. In accordance with one exemplary embodiment, airfoil bearings 70 may be used between the fan blade ring and duct to rotatably support the fan rotor 42 from the duct 46. The airfoil bearings 70 may be mounted to the duct structure. For example, the duct structure may include a re-entrant section housing the airfoil bearings 70 and able to receive, at least in part, the tip ring on the fan rotor 42. In this embodiment, the fan may not be supported from the core engine, and may be rotatably supported and held in its relative position to the coupling section 58 by the foil bearings.

The fan blades 60 may be made of any suitable material such as composites, metal or metal composite combination and may be substantially solid or hollow in cross section. As noted before each fan blade may include 60AS ducts 60A, 60B directing engine exhaust to the upper surface slots and tip jets 60T. In this embodiment each blade has two ducts 60A, 60B, though in alternate embodiments more or fewer ducts may be provided. As seen best in FIG. 5A, one duct 60A has a slotted exhaust opening that defines a span wise boundary layer control (BLC) slot 60AS along the fan blade. The slot 60AS may extend along the fan blade from substantially near the root to proximate the tip of the blade. The slot 60AS is located on the suction or upper side 60U of the fan blade, and is sized as desired to obtain the desired gas flow characteristics of exhaust gases S from the slot over the surface to delay flow separation from and generate motive force (in the direction of rotation) against the fan blade to generate thrust on the fan blade. The second duct 60B ducts turbine exhaust gases E (see FIG. 5) through the blade to tip jets 60J at the fan blade tip 9. The tip jets 60J and BLC slots 60AS act on the fan blades in effect to generate the torque for spinning the fan 42 in the desired direction (corresponding to fan blade twist, camber and angle relative to rotation R) to generate an axial thrust T (as shown in FIG. 4).

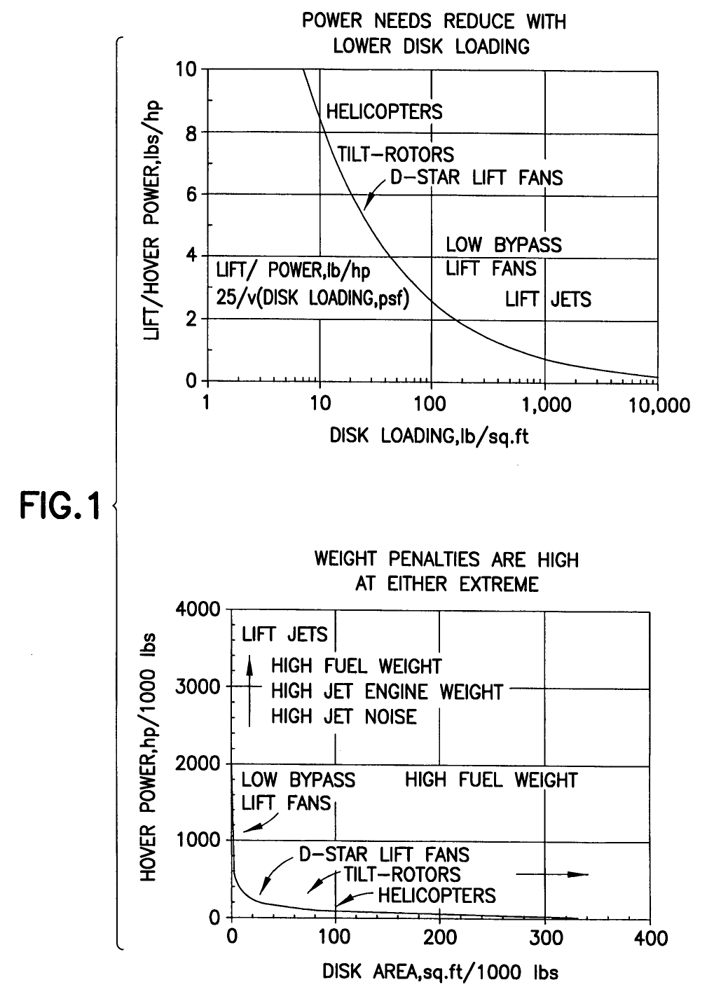

As also noted before, the fan rotor 42 has active aspiration providing for differential blowing from B1C slots 60AS on different (e.g. advancing and retreating) fan blades when desired (such as when the vehicle is traveling for example in the forward direction indicated by arrow X in FIG. 2A. In the exemplary embodiment, a flow regulator 62 is located within the fan rotor inlet 42I. In alternate embodiments, the flow regulator may be located in any other suitable location. The flow regulator 62 may be of any suitable type, and may be capable of differentially regulating the exhaust gas volume directed to the advancing blades and retreating blades. For example, the flow regulator 62 may have variable apertures or valves arranged to be able to direct more exhaust gas from engine 2E in inlet 42I to blades 60 on one side of the fan rotor 42 than blades 60 on the other side of the rotor 42. Operation of the flow regulator 62 may be controlled by a suitable controller (CTI) for example a programmable logic controller or a mechanical controller linked to vehicle control system (not shown). The variable apertures in the flow regulator 62 through which the exhaust gas in the plenum passes into the blade ducts 60A feeding the BLC slots 60AS may be operated mechanically or electro-mechanically. The opening of variable apertures of the flow regulator is varied so that desired gas flow is directed to blades 60 in a desired location of fan 12. For example, when hovering, the flow regulator may be controlled so that blowing gas S from BLC slots 60AS is substantially equal on all fan blades 60. When in forward flight (indicated by arrow X in FIG. 1), the flow regulator may be controlled so that advancing blades (e.g. in the case of counterclockwise rotation, right side fan blades moving in flight direction) have reduced blowing from BLC slots than retreating blades. As may be realized, the differential blowing may also be controlled to generate desired control moments (i.e. pitch and roll). For example, for pitch moments differential blowing would be provided between front and rear fan blades, and for roll the differential blowing between left/right fan blades would be controlled. As seen in FIG. 5, the fan rotor 42 may also be coupled to a suitable motor generator 24. Rotation of fan motor drives the generator 24. Power from the generator may be directed to the motors 3 of rear fans 28 or motors 26 of ground transport system. Conversely the motor/generator 24 may operate as a motor, rotating fan rotor 42 for engine out operation.

As seen in FIG. 4, the encapsulating fan duct 46 has an upstream portion for directing flow to the fan rotor. The upstream portion of the duct may be a typical NACA inlet 52 and crescent-shaped blown Coanda slot 54, may be used for enhanced capture of flow during forward motion of the aircraft. The inlet 52 in this embodiment is axisymmetric, but may have any other desired shape in alternate embodiments. In FIG. 4 one Coanda slot 54 is shown for example purposes in the inlet portion, and one Coanda slot 56 is shown in the exhaust portion. However, any desired number of Coanda slots may be positioned in either the inlet or exhaust to provide the desired gas flow characteristics. Referring now also to FIG. 4A, there is shown a schematic axial view of the duct inlet. As seen best in FIG. 4A, the Coanda slot 54 is located on the forward portion 52F of the inlet 52. The Coanda slot 54 is shown in FIG. 4A as having a length extending substantially to the lateral centerline CLZ of the inlet cross-section (where the slot is located) for example purposes, and in alternate embodiments the length of the slot may be varied as desired. As may be realized from FIG. 4, the inward curvature of the inlet 52, establishes an adverse pressure gradient along the forward inlet portion 52F during forward motion of the vehicle 10 indicated by arrow X), which would result in flow separation or stall of the forward inlet portion 52F. The Coanda slot 54 increases energy of the local airflow in the region, overcoming the adverse pressure gradient and preventing undesired flow separation from the forward inlet surface and thereby helping turn airflow from horizontal (i.e. parallel to movement axis X)to flow substantially aligned with the fan axis FA (see FIG. 4). As noted before, the fan axis FA is substantially coincident with the axis of symmetry of the duct inlet 52. As also seen best in FIG. 4A, the slot 54 has an effective gap 54G that varies in width along the slot length. The slot gap width varies from a minor dimension at or near the slot ends 54E (an area of the inlet where flow separation is less likely to occur) to a maximum width at a location (e.g. forwards) of the inlet where the potential for flow separation due to flow conditions is greatest. The resultant slot thus has a crescent shape as shown. As may be realized, the slot 54 is located at longitudinal distance along the duct inlet as desired for maximum aerodynamic efficiency.

Encapsulation of the fan 12 into a nacelle retains the advantages of low noise emanation and safety of operation in the urban environment with close proximity to people, building, wires, trees and other obstacles. In addition, the fan 12 and its associated nacelle are amenable to use of thrust vectoring louvers/vanes to achieve direct control over all six Degrees Of Freedom (6-D.O.F.) for maximum maneuverability in the urban environment. Also, by premixing the hot core gases with the large amounts of bypass air, the fan 12 also largely eliminates the hot gas from the engine being exhausted directly outside the vehicle.

Referring still to FIG. 4, the fan nacelle 46 has a downstream section 71 that transition from the generally axi-symmetrical portion immediately downstream of the fan motor 42 to a suitably shaped plenum exhausting through transfer duct(s) 50 (directing pressurized air from the fan to remote thrust nozzles/louvers as will be described below) ducts 20 (see also FIG. 2A) and thrust vectoring louvers/vanes 72. In the embodiment shown in FIG. 4, the plenum has a lower surface 74 that may be curved as shown to improve flow from the plenum to transfer duct(s) 50 and ducts 20. In this embodiment, as seen best in FIG. 2A there are three ducts 20, 50 fed by the plenum, though in alternate embodiments there may be any desired number of ducts to which pressurized air from fan 12 is fed by the plenum.

In FIG. 4, ducts 20 are omitted for clarity. Ducts 20 are seen best in FIG. 2B. Ducts 50, 20 are oriented such that the gas flow into the local duct entry, for example entry 50I of duct 50 from the plenum which may be best visualized from FIG. 4, is generally horizontal. Thus the flow direction of pressurized air from the fan 12 is turned from being aligned substantially with the fan axis FA to horizontal for entry into ducts 50, 20. The plenum formed by the downstream portion 7 of the fan duct 46, has a suitably rounded/shaped upper surface 77 aiding in channeling the flow of pressurized fan air to entry of ducts 50, 20. As may be realized, the largest flow turn is for entry into duct 50, and the curvature of the plenum surface 77 has the smallest bend radius in the region 77F leading to the entry 50I of duct 50. As noted before and seen best in FIG. 2A, the entry 50I to duct 50 is located on the aft side of the downstream duct portion 71, though in alternate embodiments the entry into the transfer ducts may be located in any other desired location around the perimeter of the downstream duct portion. FIG. 4B is a cross-sectional view of the downstream duct portion 71, taken along view lines B-B in FIG. 4, and best shows the portion 77F of upper surface 77 leading to the entry 50I of duct 50. This portion of the plenum surface 77 is provided with crescent shaped Coanda slot 56, generally similar to upstream slot 54 described before, the enhance flow along the upper surface in region 77F and aid turning the flow of pressurized air from fan 12 into the entry 50I for duct 50. Similar to slot 54, the width of slot gap 56G also varies along slot length from minimum at opposite ends 56B to maximum in region where the inward curvature of surface 77 has smallest bend radius.

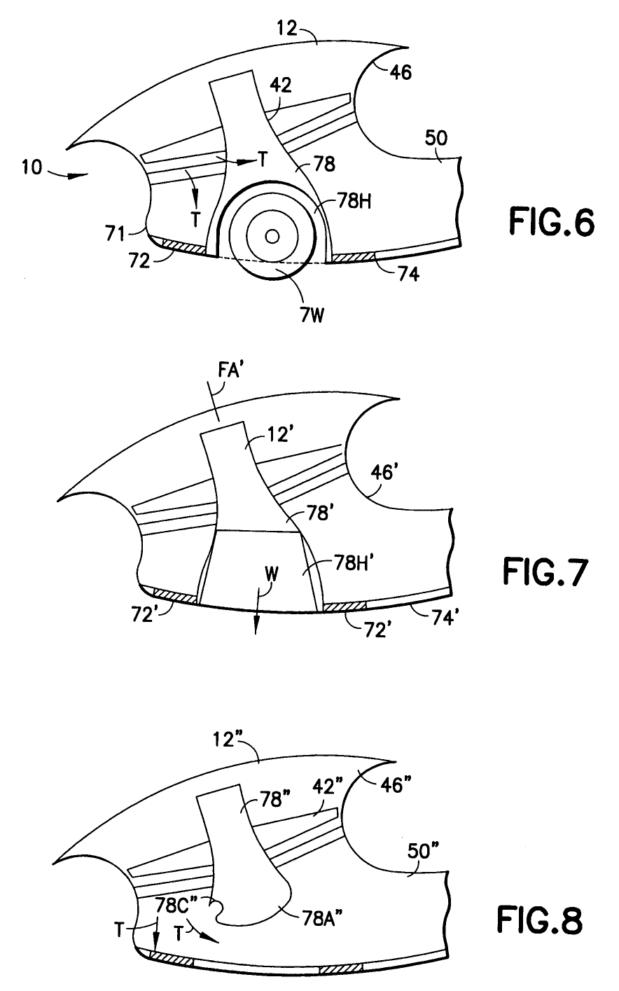

Referring again to FIG. 2B, ducts 20 direct pressurized air flow to vectoring louvers 73 located on opposite sides of the body. Louvers 73 are oriented to create lift, thrust or both. Duct 50 routes air to aft vectoring louvers 22 (see also FIG. 2C). The aft louvers 22 are shown in FIG. 2C as having an exemplary arrangement, and in alternate embodiments may have any suitable arrangement. The ports in which the vectoring louvers 73, 22 are located are shown as having a general rectangular cross-section for example purposes, and in alternate embodiments the outlet ports in which the vectoring louvers are located may have any suitable shape. In other alternate embodiments, variable geometry vectoring nozzles may be used in place of vectoring louvers for generating lift, thrust or both. Similar to forward louvers 73, the aft vectoring louvers 22 in this embodiment are oriented to create lift, thrust or both. As seen best in FIGS. 2A-2B, the duct 50 (shown in phantom) directing pressurized air to aft louvers 22 extends, in this embodiment, from the fan duct 46 in the nose section, along the longitudinal center line of the vehicle, and passes under the occupant compartment O to reach the aft louvers 22. FIG. 9 shows a cross-sectional view of the duct 50, in the area of the occupant compartment, and a representative occupant in the compartment. As shown in FIG. 9, in this embodiment the cross-section of the feed duct 50 has a general inverted “T” configuration with a lower duct section 50L and upper section 50U. The upper section 50U is narrower and projects as shown from the lower section to form the stem of the “T” shape. As also seen in FIG. 9, in this embodiment, the upper section 50U is located so that the legs of an occupant seated in the occupant compartment are located astride the upper duct section. The upper duct section may extend substantially to the occupant seat OS, though the duct wall may not form the seat surface for the occupant. The upper wall of the lower duct section 50L may form, or be located immediately below, the floor of the occupant compartment. In alternate embodiments, the feed duct to the aft vectoring louvers may have any other desired shape.

In this embodiment, a controlled surface 76 may be movably (e.g. pivotally) mounted to the plenum surface to provide the variable geometry to the transfer duct 50. As seen in FIG. 4, vectoring louvers/vanes 72 may be positioned in the lower surface 74 of the exhaust plenum. The vectoring louvers/vanes 72 may be sized and positioned to provide lift as desired and in combination with louvers 73, 22 for effecting controlled movement of the vehicle 10 about all six degrees of freedom (i.e. thrust for movement along vertical, longitudinal, and lateral axes; and thrust moment for rotation about pitch, roll and yaw axes). A control system, not shown, is coupled to the fan 12 and thrust vectoring louvers/vanes 72, 73, 22 to allow an operator (that may be a person, or a programmable autonomous operator) to control six degrees of freedom movement of the vehicle. The louvers/vanes 72 as well the variable geometry control surface 76 of the aft facing nozzles 50 may be powered by any suitable actuation system including hydraulic, pneumatic, electrical or piezoelectrical actuation systems.

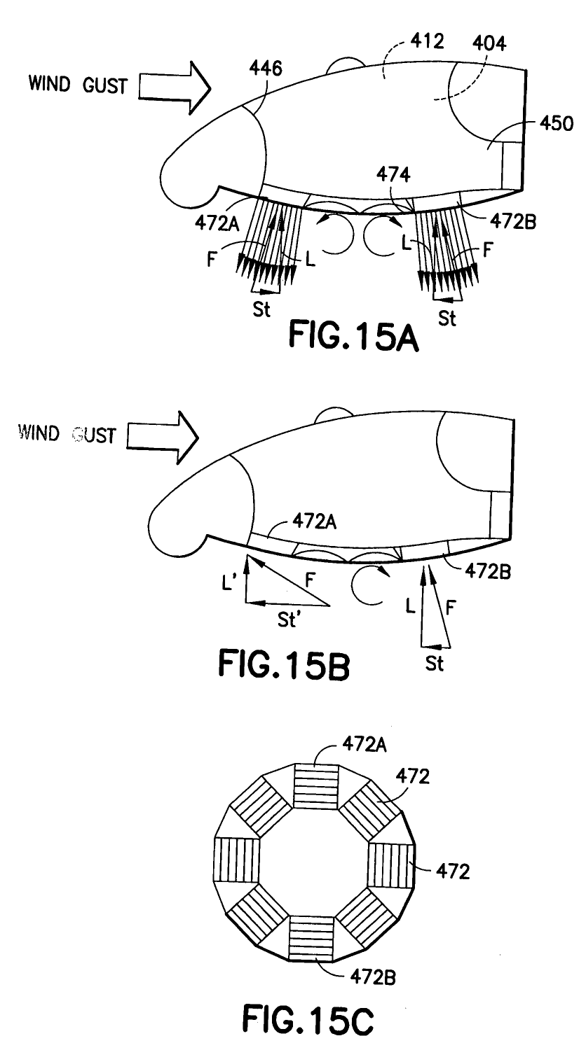

The vectoring louvers 72, 73, 22 through which pressurized air from fan 12 is exhausted are each arranged in this embodiment in opposing louver pairs. For example, the bottom vectoring louvers 72 (see also FIG. 4) forming the nose louver array 18, each have two opposing vectoring louver sections 72A, 72B. Three louver pairs 72A, 72B are shown in FIG. 2A for example purposes and alternate embodiments may have any desired number. The respective louvers of each louvering sections 72A, 72B are independently actuable so that the gas exhaust through each louver section 72A, 72B may be independently varied. The louvers of each louvering section may be capable of rotating from fully open position (maximum flow) to fully closed (no flow) positions, and may be stably located in any desired intermediate position. The rotation or movement of the respective louvers in the opposing sections may be in generally opposing directions. For example, when moving from closed to open positions the respective louvers of the opposing sections may move in away from each other (e.g. opening outwards). The opposing lower sections may also be angled and in opposing directions with respect to each other so that gas exhausted from the opposing louvers, with the louvers fully opened, is vectored in a manner similar to that shown in FIG. 15A in directions having a generally opposing reaction component. As may be realized, a form opened position, exhaust gas vectors are balanced and the opposing reaction component from the opposing louver exhaust cancel each other for steady state lift/thrust. The opposing louver sections may be differentially controlled, so that the exhaust gas vectors from the louver sections 72A, 72B are unbalanced (in a condition similar to that shown in FIG. 15A for maneuvering.

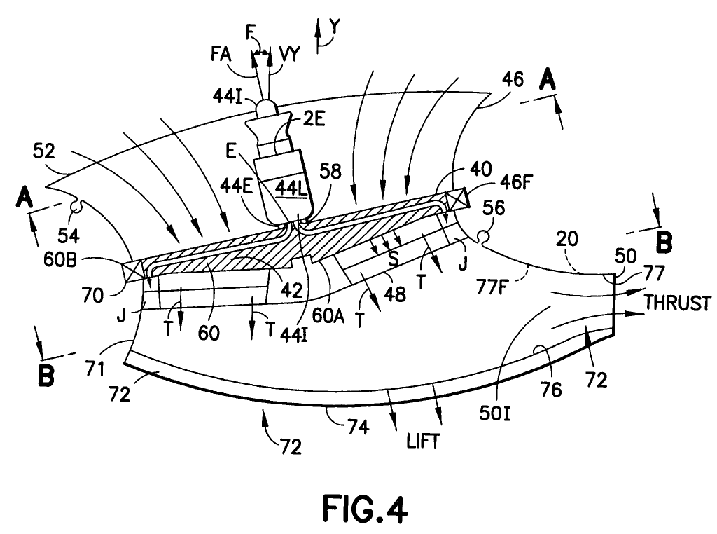

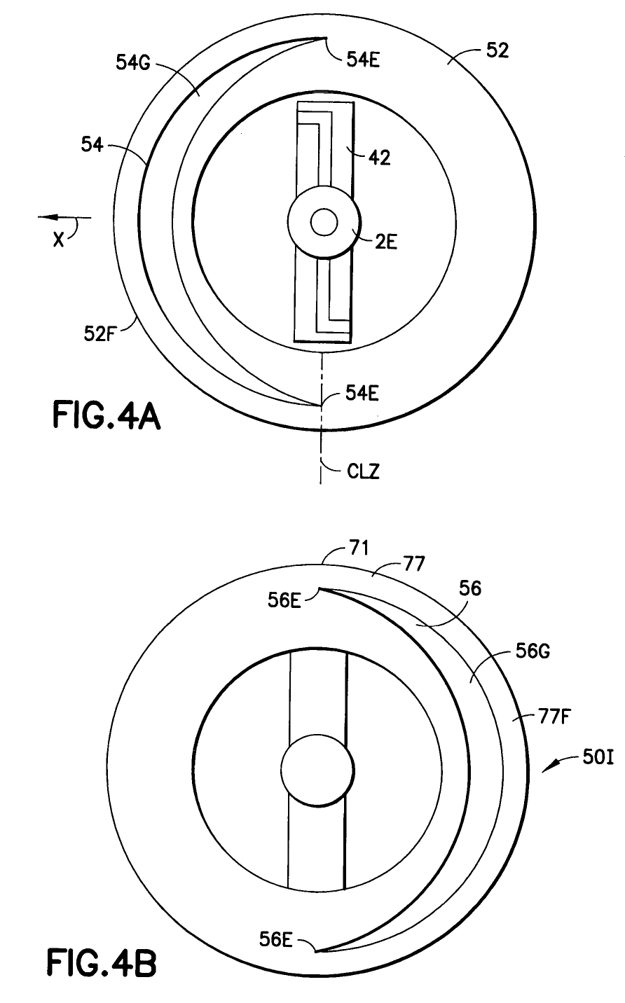

Referring now to FIG. 6, there is shown another schematic cross sectional view of the nose off vehicle 10. The view in FIG. 6 is similar to that shown in FIG. 4, but further showing the aft hub section 78 of the fan duct 46 and portion (in this embodiment a wheel 7W) of the vehicle ground support/transport system. In this embodiment, the wheel 7W is housed in the duct hub section 78. The duct HVV section, as seen in FIG. 6, may continue from the fan rotor 42 to the bottom surface of the downstream portion 71 of duct 46. The duct hub section 78 may have any desired exterior shape to allow pressurized air from the fan in the plenum of duct section 71 to flow around the hub section 78 to transfer ducts 20, 50 (see also FIG. 2A). The duct hub section 78 may have a hollow interior shaped to form a holding 78H for the wheel 7W. The wheel housing 78H may be sufficiently large so that the wheel 1W may be located therein with but the lower portion of the wheel protruding below the bottom surface 74 of the duct 46. FIG. 7 is another cross-sectional view showing the fan 12′ and duct 46′ in accordance with another exemplary embodiment. Except as otherwise noted, fan 12′ and duct 46′ are substantially similar to fan 12 and fan duct 46 described before and shown in FIGS. 4 and 6 and similar features are similarly numbered. In this embodiment, duct 46′ has hub 78′. The duct hub 78′ is hollow and defines a payload housing 78H′ with in the hub. In this embodiment a portion of the vehicle ground support/transport system, may or may not be located in the payload housing 78H′ as desired.

In this embodiment, the payload housing 78H′ may be positioned so that a payload located therein has a center of gravity (CG) (indicated by arrow N in FIG. 7) that is substantially coincident with the center of lift developed by vectoring louvers 72′ in the bottom 74 of the fan duct. In this embodiment the fan axis FA′ may also be substantially aligned with the payload CG.

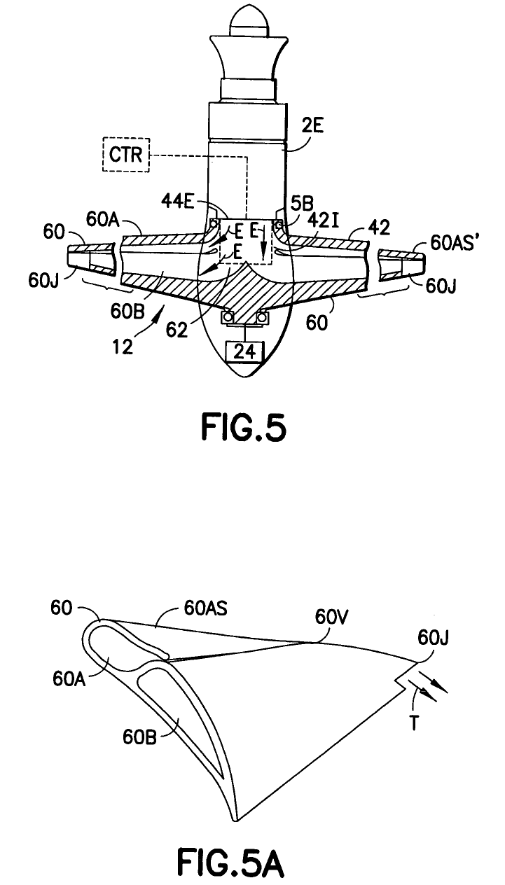

Refer now also to FIG. 8, there is shown yet another cross-section of a ducted fan 12″ in accordance with yet another exemplary embodiment. Except as otherwise noted, ducted fan 12″ is substantially similar to the ducted fan 12, 12′ shown in FIGS. 4, 6 and 7, and again similar features are similarly numbered. In this embodiment, the duct hub 78″ of fan duct 46″ has a closed bluff aft end 78A″. The closed end 78A″ of the hub 78″ has a generally rounded section to enhance flow T in the duct plenum of pressurized air from the fan rotor 42″ to the transfer ducts 50″ feeding the aft facing thrust louvers (similar to louvers 22 in FIG. 2C). A Coanda slot 78C″ which may be crescent shaped similar to slot 56 (see FIG. 4) may be provided in rounded surfaces of the hub end 78″ to prevent flow separation and aid turning the flow T around the hub end.

The fan 12 thus enables the creation of the proposed new generation of V/STOL air-vehicles 10 capable of improved mobility, speed, range, deployability and sustainability. As depicted in the tables below, the performance projections for this type of vehicle 10 in possible different exemplary configurations are indicative of high speed capability, combined with long endurance and large payloads.

| | | |
|---|---|---|
| Parameter | Max. Pay load | Max. Fuel |

Each Vehicle Carrier 1 or 1 or 2 Soldiers,
Two Vehicles Fit In One V-22

| Dimensions | Body Length | 144 inches | | (12 ft.) | |
|---|---|---|---|---|---|
| | Body Width | 66 inches | | (5 ft. 6 in.) | |
| | Fan Diameter | 54 in. | | (4 ft. 6 in.) | |
| | Overall Length (incl. Tails) | 156 inches | | (13 ft.) | |
| | Span/Body Width | 66 inches | | (5 ft. 6 in.) | |
| Weights | Airframe + Engine(s) | 1000 | | lbs. | |
| | Payload | 600 | lbs. | 400 | lbs. |
| | Fuel | 400 | lbs. | 600 | lbs. |
| | Gross Take-Off Weight (VTO) | 2000 | | lbs. | |
| Powerplant(s) | Take-Off Engine, Fuel | | | | |
| | Core Jet Thrust | 500 | | lbs. | |
| | Core Jet Thrust - SFC | 1.1 | | lbs [symbol] hr | |
| | Fan Lift Thrust - SFC | 0.22 | | lbs [symbol] hr | |
| | Cruise Engine, Fuel | | | | |
| | Micro-Diesel Power | | | | |
| | Micro-Diesel BSFC | | | | |
| | Fan Cruise Thrust - SFC | | | | |
| Performance | Max. Endurance (incl. 0.25 Hours @ Hover) | 1.3 | hours | 2.1 | hours |
| | Speed for Endurance | 185 | mph | 180 | mph |
| | Max. Range | 233 | miles | 401 | miles |
| | Speed for Range | 275 | mph | 270 | mph |
| | STO Speed | 87 | mph | 82 | mph |
| | Max, S [symbol] t. Speed, Lift Engine | 382 | mph | 384 | mph |

Each Vehicle Carries 0or 1 or 2 Soldiers;
Three Vehicles Air-Deployed from One C-130

| Dimensions | Body Length | 168 inches | | (14 ft) | |
|---|---|---|---|---|---|
| | Body Width | 66 inches | | (5 ft. 6 in.) | |
| | Fan Diameter | 54 in. | | (4 ft. 6 in.) | |
| | Overall Lenght (incl. Tails) | 130 inches | | (15 ft) | |
| | Span over Sp [symbol] | 182 inches | | (8 ft. 6 in.) | |
| Weights | Airframe + Engine(s) | 1250 | | lbs. | |
| | Payload | 600 | lbs. | 400 | lbs. |
| | Fuel | 650 | lbs. | 850 | lbs. |
| | Gross Take-Off Weight (STO) | 2500 | | lbs. | |
| Powerplant(s) | Take-Off Engine, Fuel | | | | |
| | Core Jet Thrust | 500 | | lbs. | |
| | Core Jet Thrust - SFC | 1.1 | | lbs [symbol] hr | |
| | Fan Lift Thrust - SFC | 0.22 | | lbs [symbol] hr | |
| | Cruise Engine, Fuel | | | | |
| | Micro-Diesel Power | | | | |
| | Micro-Diesel BSFC | | | | |
| | Fan Cruise Thrust - SFC | | | | |
| Performance | Max. Endurance (incl. 0.1 Hours @ Hover) | 2.7 | hours | 3.6 | hours |
| | Speed for Endurance | 160 | mph | 157 | mph |
| | Max. Range | 493 | miles | 664 | miles |
| | Speed for Range | 240 | mph | 235 | mph |
| | STO Speed | 69 | mph | 66 | mph |
| | Max. S [symbol] t. Speed, Lift Engine | 371 | mph | 371 | mph |

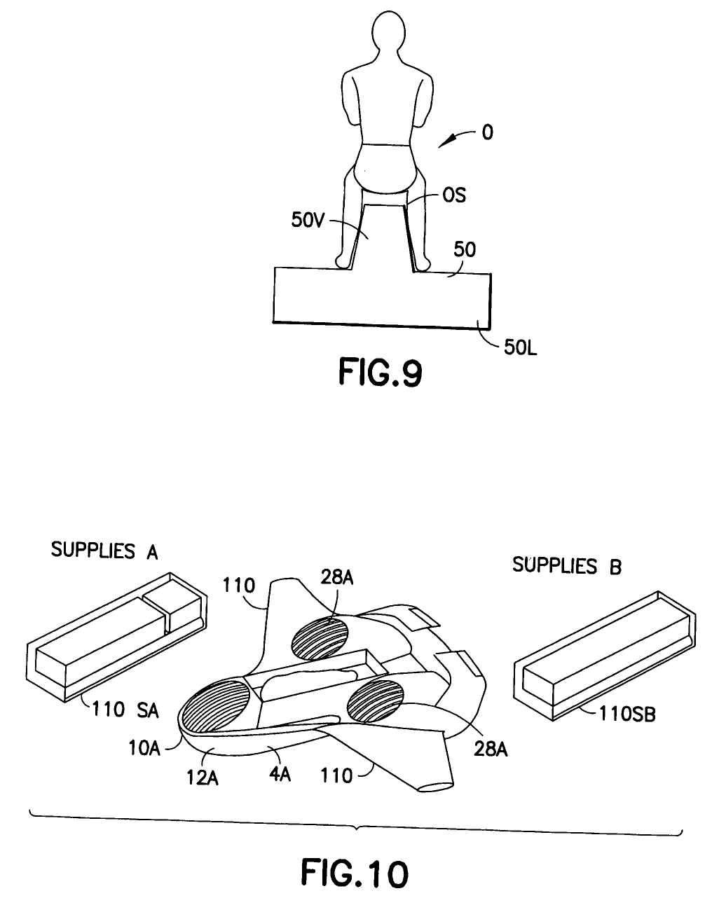

In accordance with another exemplary embodiment, hybrid manned/unmanned air vehicle 10A is illustrated in FIG. ??. Vehicle 10A is similar to the vehicle 10 described before and shown in FIGS. 2A-2C. Vehicle 10A may have a similar engine/motor and lift/thrust fan system 4A with front 12A and rear fans 28A. It also has folding wings 110 for long endurance/range when ambient space is adequate for wing deployments. FIG. 10 shows different interchangeable payload containers 110S, 110SA, 110SB that may be carried in the payload bay of the vehicle. One payload container 110S contain an injured person, or various packs 110SA, 110SB ma hold different desired supplies.

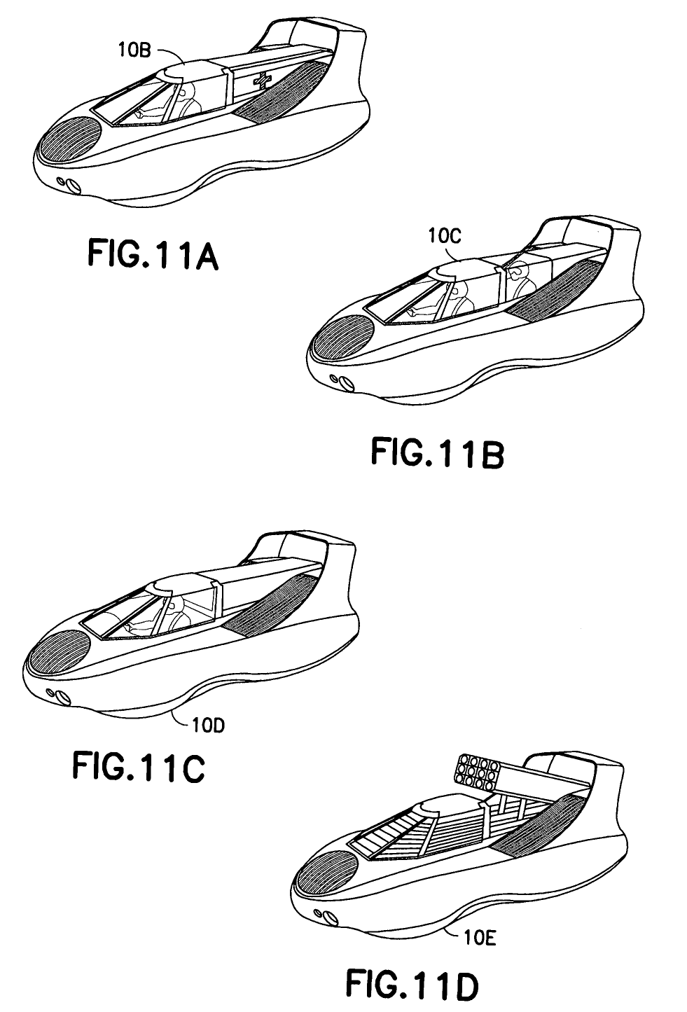

FIGS. 11A-11D are schematic perspective views that illustrate other exemplary embodiments of the vehicle 10B-10E that is a slightly larger design that accommodates a pilot plus one MISO Pack, or two persons plus a Half-MISO Pack. The system for example may be 14 ft. long and 7 ft. wide, about the size of a Humvee. It carries one or two persons but can carry any other desired payload.

Engine-Out Power Transmission System and Mobility on Ground

For safety of manned flight, it is desirable to have multiple fans, such as fan 12, and fans 28, such that the loss of performance from any one engine does not result in loss of control and enables continued safety of flight in any operating mode. Conventional means of power transfer include angled gear drives, cross shafts, clutches and combining gear boxes, creating excessive weight, complexity and maintenance issues. The vehicles 10, 10A, 10B achieve power transfer by combination of ducting of high pressure air and by electric power transfer through the use of light-weight, high-speed, motors/generators.

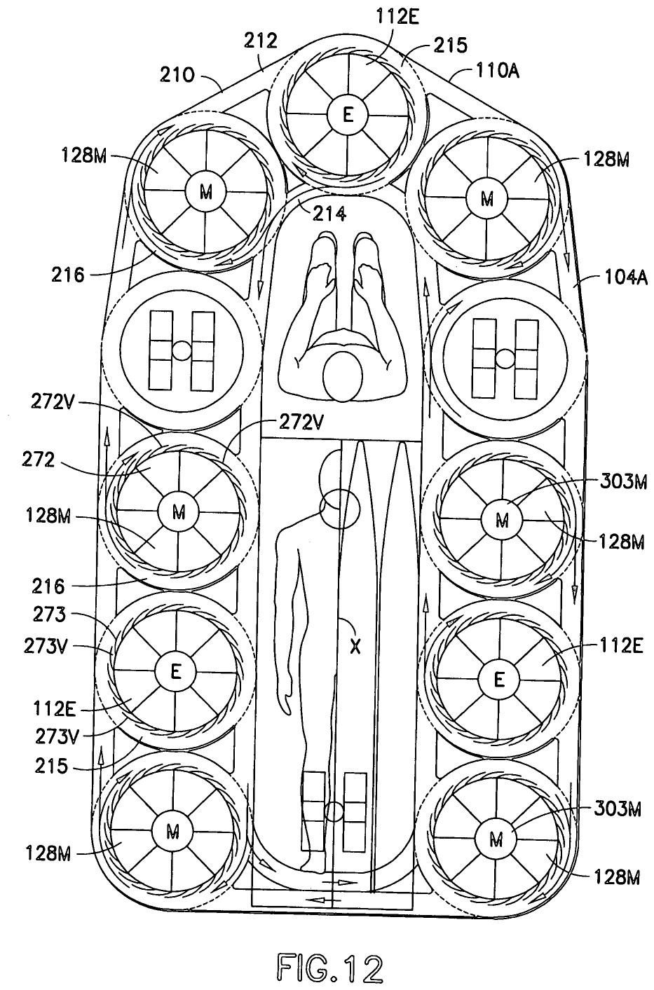

Referring now to FIGS. 12, 12A-12B there is shown a schematic plan view of a vehicle 110A in accordance with another exemplary embodiment, and respective cross-sectional of an engine fan and motor fan of the venicle lift thrust system 104A. Vehicle 110A is generally similar to vehicle 10 described before and similar features are similarly numbered. The vehicle 110A has a lift/thrust fan system 104A with multiple engine driven fans 112E and multiple motor driven fans 128M. The fan arrangement shown in FIG. 12 is exemplary and in alternate embodiments, any vehicle may have any suitable fan arrangement. The fans 112E, 128M are ducted fans, with the fans located in nacelles or fan ducts as shown. The engine fans 112E and motor fans 128M are in this embodiment generally of similar diameter, and the engine fans 112E are referred to below as primary fans and the motor fans are referred to as secondary fans for convenience. The primary fans 112E are substantially similar to fan 12 shown in FIG. 4, having an active aspirated fan rotor similar to rotor 42 (see also FIGS. 5-5A). The fan ducts of both the primary and secondary fans communicate, through closable ports (as will be described below) with ducts that may interconnect fan ducts of the lift/thrust system to each other. As shown in FIGS. 12, 12A-12B, the high pressure air from each of the Primary Fans 12B is ducted into two ducts, 212, 214 one flowing clockwise and the other flowing counterclockwise, and then onto multiple tip-driven Secondary Fans 312 for creation of lift. In the embodiment shown in FIG. 12, vehicle 10A has three primary fans 112E and six secondary fans 128M distributed symmetrically with respect to the longitudinal axis of symmetry X of the vehicle. In alternate embodiments, the vehicle may have any desired number of primary and secondary engines, positioned in any desired manner in the vehicle. In this embodiment, the fan duct 270 has a portion 271 downstream of the fan with exhaust ports 273 through which the exhaust portion of the nacelle communicates with ducting system 210 (see also FIG. 12A). Radial exhaust interface ports 273 may be gated or vaned for back pressure control as will be described below. As seen in FIG. 12, ducting system 210 includes outer ducts 212 and inner ducts 214 (though any other desired arrangement of ducts may be used) and intermediate feed and supply plenums 216, 215. Supply plenums 215 have a general annular shape and surround the primary fans 112E. High pressure air from primary fans 112E enters the supply plenum 215 from nacelle 270 through vaned radial interface 273. The supply plenums 215 communicate with both ducts 212 and 214 through suitable ports as shown in FIG. 12. The clockwise flow of high pressure air, from the primary fans 112E through vanes 273V of interface 273, inside the supply plenums 215 (in this embodiment) in turn generate respective clockwise and counter-clockwise flow of high pressure air in ducts 212, 214.

Feed plenums 216 (see also FIG. 121B), are generally similar to supply plenum 215, but surround fan nacelle 346 of secondary fans 128M and have vaned interface or ports 272 allowing flow from the plenum 216 into fan nacelles of secondary fan 128M. Secondary fan 128M has a fan section 340, as shown in FIG. 7B, that may be configured generally similar to fan section 40 of fan 12. Secondary, fans 128M, however as will be described below, may not have a core gas turbine engine. Rather, fan 312 is spun by pressurized air from feed plenums 216, exhausting through tip blades 340J. In this embodiment, the nacelle 346 may have suitable air flow slots (not shown), for example distributed circumferentially around the nacelle, fed by interface/ports 272 and positioned in proximity to catch blades formed at the tips of the fan blades 342. The catch blades may be internal or external to the fan blades. If desired, the fan blades 342 may also have longitudinal boundary layer control slots, similar to slots 60 but fed by the gas inlets at the fan blade tips. The two ducts 212, 214 of duct system 240 ensure tangential collection of pressurized air from each of the working Primary Fans, and into each of the desired Secondary Fans 128M. This ensures management of the center of lift to be at the correct location for all operating condition regardless of which primary engine-drive fan is operational.

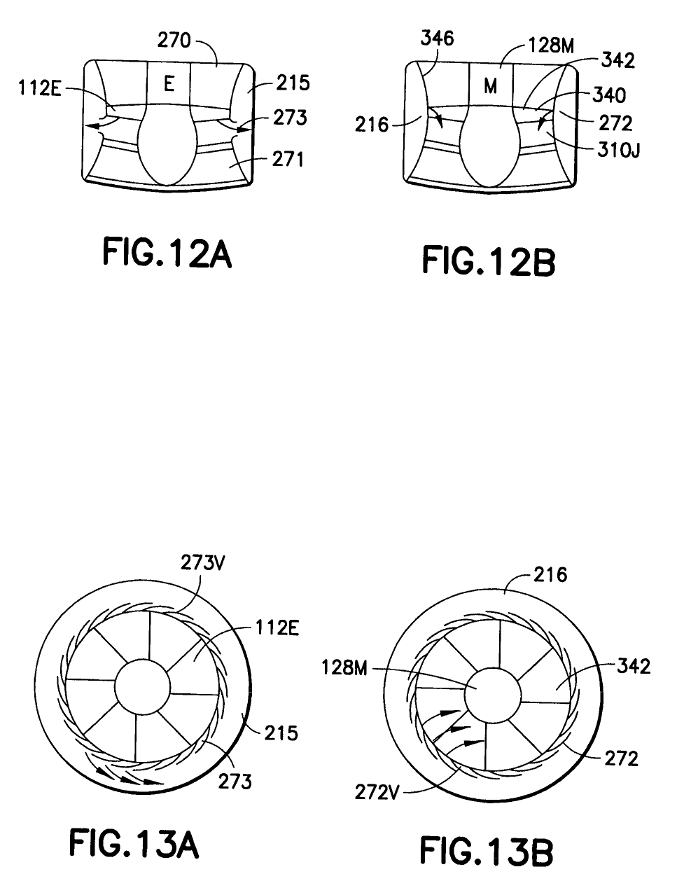

As shown in FIGS. 13A-13B, back pressure for each of the primary fans 112E is balanced by use of tangential vanes 273V in the circular interface between the radial fan outlet 273 and the tangential interconnecting plenum ducts 215. These vanes 273 may be simple mechanical cantilevered structures that are biased such that air pressure at the discharge of the primary fans 112E causes the vanes 273V to open outward into the cross-connecting ducts 215, but lack of adequate air pressure (i.e. fan pressure is lower than duct pressure), such as by a non-working primary engine-drive fan 112E, causes the vanes 273V to close by self-spring action. This auto-actuation of the vanes may be assisted or overruled by incorporating piezo-active materials that deflect under electric charge. Similar biased vanes 272V can be used to control the amount of air entering the Auxiliary Lift Fans, 312 from the pressurized feed plenum 216. For example high pressure air directed to the feed plenum 216 by transfer ducts 212, 214, cause the vanes 272V to open (inwards), allowing high pressure air to enter fan nacelle 346 and impinge on the fan rotor 342 catch blades to rotate the secondary fan. The vanes 270V may be biased to close in the event air pressure inside nacelle 346 and plenum 216 is substantially equal. Further, if back pressure of the secondary fans exceeds air pressure in the ducts, the vanes 272V are caused to shut by fan back pressure. Auto-actuation of vanes 272V may also be assisted or overruled by using piezo-electric materials in the valves.

Additional power transfer from the engines or engine-driven primary fans 112E to the secondary fans 168M may be achieved by generation of electrical power with light-weight, high-speed motor generators coupled to or mounted on the engines or primary fans 112E in a manner similar to that shown in FIG. 4 transfer of the electrical power to motors 303M coupled to or mounted on the secondary fans 128M is provided by a suitable electrical conduit system (not shown). By modulating the amount of electrical power supplied to each of the secondary fans 128M, additional controllability of the air vehicle can be achieved to supplement the thrust vector management by the louvers (similar to louvers L2 in FIGS. 2A and 4) below each of the fans or air ejectors (not shown) located at suitable places in the air vehicle. Also, in the event the engine of a primary fan 112E becomes inoperable, the motor/generator coupled to the fan may be operated as a motor for sustained operation of the primary fan with its engine out. The motor may also be used to supplement engine operation of the fan 112E as desired.

For maneuvering on the ground, electrical power from the engines/primary fans 112E may be transferred to wheel motors in one or more of the ground wheels. The same electrical power may also be used to provide for vehicle avionics demands. This allows the vehicle 110A also to achieve a measure of mobility on the ground, if desired at low speeds, to avoid the fuel consumption and noise of hovering flight. Because the vehicle 110A achieves a measure of power transfer in engine-out situations by electrical means, the same engine-driven generators can provide electric power to wheel motors for a measure of ground mobility.

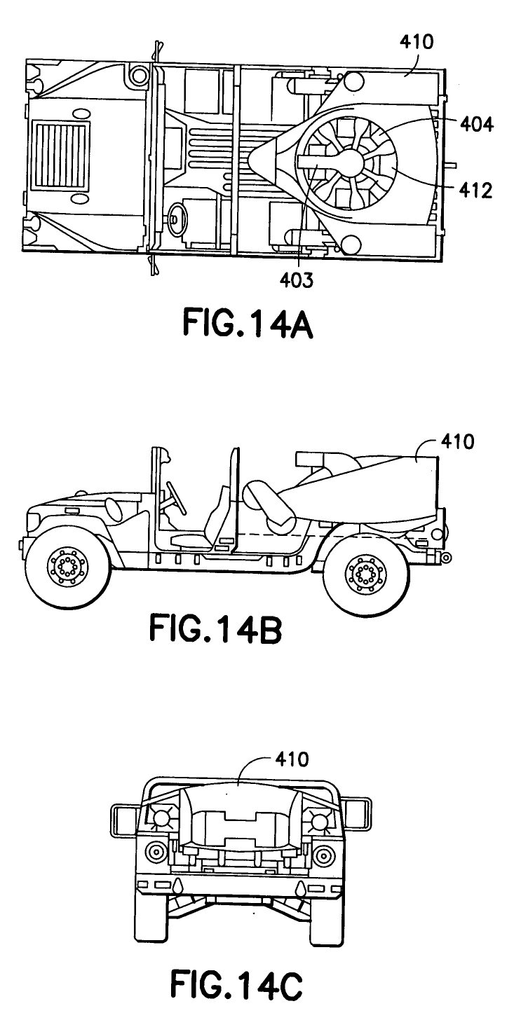

Referring now to FIGS. 14A-14C, there is shown another exemplary embodiment of a scalable unmanned air vehicle 410C and a transport vehicle, such as a Humvee, which is shown to provide dimensional scale to vehicle 410. Vehicle 410 is capable of being transported by the transport vehicle. The vehicle 410 in this embodiment is also substantially similar to vehicles disclosed in U.S. patent application Ser. No. 11/201,441 previously incorporated by reference herein. Vehicle 410 has a lift/thrust fan system 404 powered by an engine 403. The engine 403 and lift/thrust fan system 404 of the vehicle 410, is substantially similar to engine 3 and fan 12 of vehicle 10 described before and shown in FIGS. 4, 5-5A. In this embodiment, the vehicle lift/thrust fan system 404 uses one fan 412 of the appropriate size to achieve an optimum combination of hover capability and efficient cruise operation. Referring also to FIGS. 15A-15C, there is shown respectively schematic cross-sectional views of the vehicle 410 in different conditions, and a schematic partial bottom view of variable/vectoring louvers 472 of the vehicle lift/thrust system. The fan 412 and engine 403 are omitted in FIGS. 15A-15C for clarity. FIGS. 15A-15B schematically show the fan duct 446 (for ducted fan 412) and ducting 450 directing fan air to aft vectoring louvers (not shown) of the vehicle. The fan duct 446 may be similar to fan duct 46′ shown in FIG. 7. The fan duct 446 directs high pressure fan air to exhaust through vectoring louvers 472 in the bottom surface 474 which are oriented to provide lift or thrust or a combination thereof. An exemplary arrangement of the bottom facing louvers 472 is shown in FIG. 15C. In this embodiment, opposing louver pairs 472B, 472A are located on opposite sides of the vehicle. In alternate embodiments, the bottom louvers have any other desired arrangement. FIG. 15A shows the vehicle in substantially steady state condition FIG. 15B illustrate conditions of vehicle 410 upon encountering a longitudinal or lateral gust of wind. The wind gust may be detected by any suitable system (e.g. on board accelerometers). In response, the control system (not shown) commands appropriate pairs of louvers 472A, 472B to differentially open/close to generate a lateral force ST′, ST countering the wind force for station keeping. As may be realized, the vectoring of the thrust of louver 742A to counter the wind gust, causes a reduction in this case in the lift component L′, creating a beneficial nose down pitching moment of vehicles 410 helping the vehicle station keeping vertical/downward gusts may be countered by similar vectoring of opposing louver pairs. The louver system that offers direct control over six degrees of freedom (6-D.O.F. control) for precise maneuvering and gust compensation. Vehicles 410 thus may be a highly maneuverable sensor system that can land and move around on the ground using electric wheel motors, or land on top of a building for ‘perch & stare’, or hover with relatively high efficiency to look through windows of buildings, or fly efficiently preprogrammed commands or remote control instructions. This UAV 410 may respond to a distress call and either deliver 300 pounds of desired supplies to a precise location, or pick up a person, or assist a person to get over vertical obstacles.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A vehicle comprising:
a body;
an engine connected to the body; and
an engine driven fan mounted to the body for providing thrust capable of effecting controlled motion of the vehicle in at least one direction, the fan comprising a fan section drivingly connected to the engine, wherein the fan section has fan blades, at least one of which has a tip jet and a boundary layer control slot formed therein.

2. The vehicle in accordance with claim 1, wherein the engine is an air breathing gas turbine engine.

3. The vehicle in accordance with claim 1, wherein the fan is a ducted fan.

4. The vehicle in accordance with claim 1, wherein the fan is an high-bypass ratio fan.

5. The vehicle in accordance with claim 1, wherein the boundary layer control slot is a spanwise oriented slot.

6. The vehicle in accordance with claim 1, wherein the fan blades are rotated by engine exhaust gas exhausting from the tip jet.

7. A vehicle comprising:
a body;
an engine connected to the body; and
an engine driven fan mounted to the body for providing thrust capable of effecting controlled motion of the vehicle in at least one direction, the fan having an active aspirated fan rotor with upper surface blowing, the fan rotor being operably coupled to the engine for engine exhaust gas to aspirate the fan rotor.

8. The vehicle in accordance with claim 7, wherein the fan rotor has differential blowing between different fan blades.

9. The vehicle in accordance with claim 8, wherein the differential blowing is between advancing and retreating blades.

10. The vehicle in accordance with claim 7, wherein the fan is a ducted fan.

11. The vehicle in accordance with claim 7, wherein the fan is located in a fan duct having an inlet with Coanda slot blowing.
